(19) United States
(12) Patent Application Publication
(10) Pub. No.: US 2005/0018838 A1
(43) Pub. Date: Jan. 27, 2005

(54) Communications headset with isolating in-ear driver

(75) Inventors: Jeffrey A. Meunier, Deerfield, IL (US); Scott C. Grinker, Vernon Hills, IL (US); Christopher P. Lyons, Naperville, IL (US); Richard J. Santiago, Racine, WI (US); Michael A. Moffit, Spring Grove, IL (US)

Correspondence Address: BANNER & WITCOFF, LTD., TEN SOUTH WACKER DRIVE, SUITE 3000, CHICAGO, IL, 60606, US

(73) Assignee: Shure Incorporated, Niles, IL (US)

(21) Appl. No.: 10/791,011

(22) Filed: Mar. 2, 2004

Related U.S. Application Data
(60) Provisional application No. 60/451,810, filed on Mar. 3, 2003.

(51) Int. Cl. H04M 1/00; H04M 9/00

(52) U.S. Cl. 379/431

(57) ABSTRACT

The present invention relates to a communications headset. The headset comprises a housing that includes a speaker driver. The headset further comprises a nozzle for insertion into an ear canal. The nozzle is coupled to the housing. The headset additionally comprises an acoustically isolating ear piece coupled to the nozzle, the ear piece and the housing providing of acoustic isolation from ambient sound over the range of audible frequencies. The headset further comprises a microphone.

This application claims priority to provisional U.S. Application Ser. No. 60/451,810 that was filed on Mar. 3, 2003, the entire disclosure of which is hereby incorporated by reference.

### FIELD OF THE INVENTION

The present invention relates to a communications headset with an isolating in-ear driver, and, in particular, to a sound isolating earphone with attached microphone apparatus.

### BACKGROUND OF THE INVENTION

Difficulties often arise when using a communication system such as a mobile telephone in a noisy environment. For example, in such an environment, a user may be unable to clearly hear the far end talker, the person on the other end of a telephone call. Improving the signal to noise ratio improves the experience for the user by making the person on the other end easier to hear and understand and therefore making communication easier.

Such signal to noise ratio improvement is desirable whether background environment noise is speech-like or non-stationary, for example at a social gathering or at a train station, or where the background noise is more constant, for example, noise originating from an automobile, airplane or machinery.

Some users of mobile telephones prefer to operate the telephones in a “hands free” mode that allows the user to speak and listen without using his or her hands. Typically users desiring such hand free operation use headsets that employ standard earphones, which generally enclose a user's ear or rest on top of the ear. Regular earphones, such as “earbuds” often packaged with mobile phones, rest on the outside of the ear. Such headsets typically include a microphone.

Such headsets do little, if anything, to block or cancel background noise from entering the users ear. A user of a typical headset or earbud must hold a hand over his or her ear or hold the earpiece closer to their ear to block out unwanted noise and hear the other end of the conversation. The process of putting a hand to an ear defeats the “hands free” purpose of the headset.

Additionally, typical headsets may also be uncomfortable to wear and may not remain mounted on a user's head.

Some systems combat background noise with active noise cancellation systems that attempt to add an “anti-noise” signal to the desired signal to cancel unwanted noise. Such systems are expensive because they require additional logic and are not necessarily effective in situations of dynamic noise environments. Active noise cancellation headphones are generally larger and heavier than other headphones. The active cancellation process negates selected frequencies through a complex process that can even introduce unwanted artifacts into the resulting audio. Additionally, the process is battery-driven and would add additional drain to a battery, which may be undesirable in situations where battery size, weight and drain are important.

Therefore, there is a need in the art for an inexpensive communications headset that effectively blocks background noise, is comfortable to wear, and effectively remains affixed to a user's head.

### SUMMARY OF THE INVENTION

One or more of the above-mentioned needs in the art are satisfied by the disclosed communications system.

In a first embodiment, a communications headset is provided. The headset comprises a microphone, a speaker driver, a nozzle for insertion into an ear canal and an acoustically isolating earpiece coupled to the nozzle. The ear-piece is comprised of an outer sleeve attached to an inner cylindrical, rigid tube. The flexible sleeve frictionally engages the ear canal and provides acoustical isolation. The ear piece ideally provides 15-25 dB of isolation when a full acoustical seal is achieved between sleeve and ear canal. The microphone is coupled to the system via a boom and a cable extending from the speaker driver. The cable provides an input signal to the speaker driver and an output signal from the microphone.

In one embodiment, the sleeve may be comprised of compressible closed-cell foam that forms to engage the ear canal and an inner cylindrical, rigid tube. The inner cylindrical tube frictionally engages the nozzle, attaching the ear-piece to the speaker driver.

In other embodiments, the sleeve may be comprised of flexible plastic or silicone with an outer portion that forms to engage the ear canal and an inner portion that is a cylindrical tube. The inner cylindrical tube frictionally engages the nozzle, attaching the ear-piece to the speaker driver.

The ear piece may take various shapes and may provide open passages to external noise. In this embodiment, the amount of isolation is purposely reduced compared to a design with no open passages.

The communications headset may be supported on the user's head solely by the ear piece and without additional fasteners or attachment mechanisms.

The boom may be rigidly or hingedly affixed to the case. The boom may be flexible or stiff. A flexible cable extending from the case extends in the same direction as the boom such that the unit can be worn on a left or a right ear.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows a communications headset in accordance with an embodiment of the invention.

FIG. 2 shows a communications headset with a rigid, nonhinged boom in accordance with an embodiment of the invention.

FIG. 3 shows a communications headset with a flexible, hinged boom in accordance with an embodiment of the invention

FIG. 4 shows a communications headset with a flexible, nonhinged boom in accordance with an embodiment of the invention.

FIG. 5 shows detail of structural components of an embodiment of the invention.

FIG. 6 shows detail of structural components of a control and volume assembly that can be included in an embodiment of the invention.

FIG. 7 shows detail of structural components of an embodiment of the invention.

FIG. 8 shows the embodiment of FIG. 7.

FIGS. 9-12 show alternative ear piece devices in accordance with various embodiments of the invention.

FIGS. 13 and 14 show additional detail of the portion of an embodiment of the invention that is coupled to a user's ear.

FIG. 15 shows additional detail of detail of the portion of an embodiment of the invention that is coupled to a user's ear.

FIG. 16 shows engagement of a component of an embodiment of the invention with a user's ear canal.

FIG. 17 shows an alternative embodiment of the present invention.

FIG. 18 shows an overhead perspective of the embodiment shown in FIG. 17.

FIG. 19 shows a side view of the embodiment shown in FIG. 17.

FIG. 20 shows an end view of the embodiment shown in FIG. 17.

FIG. 21 shows the embodiment of FIG. 17 with an intersecting plane.

FIG. 22 is an alternative view of the embodiment shown in FIG. 21.

### DETAILED DESCRIPTION

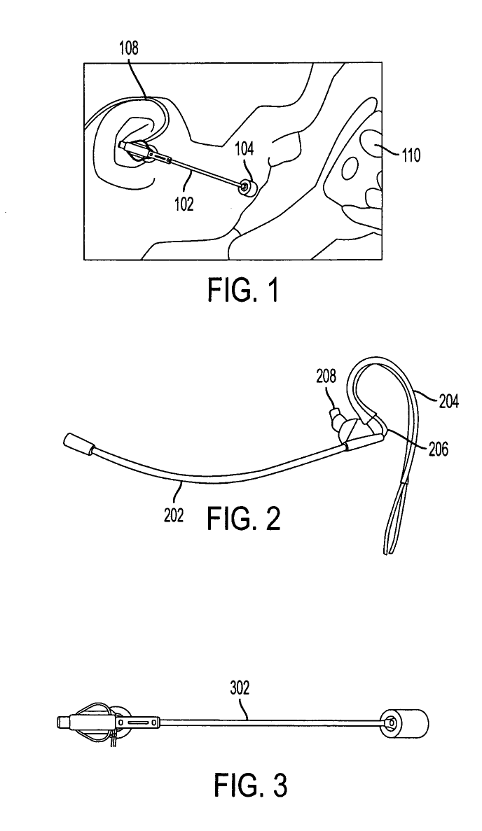

FIGS. 1-4 show various embodiments of a communications headset in accordance with the invention. FIG. 1 shows a communications headset 102 in accordance with an embodiment of the invention. The headset is mounted on user's head and includes a microphone 104 affixed to a boom 106. A flexible cable 108 extends from the unit to a mobile telephone 110.

FIG. 2 shows a communications headset with a rigid, nonhinged boom 202 in accordance with an embodiment of the invention. In this embodiment, a cable 204 flexibly and fixedly extends from a base 206. A nozzle 208 and boom 202, in this embodiment of the invention, must exit the base 206 with a geometry compatible with the human anatomy, such that the boom 202 places the microphone sufficiently close to the user's mouth and such that the nozzle 208 can be comfortably inserted into the user's ear canal.

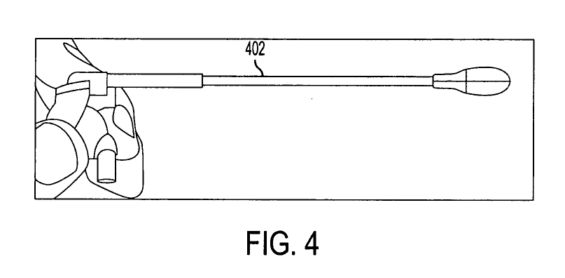

FIG. 3 shows a communications headset with a flexible, hinged boom 302 in accordance with an embodiment of the invention. FIG. 4 shows a communications headset with a flexible, nonhinged boom 402 in accordance with an embodiment of the invention.

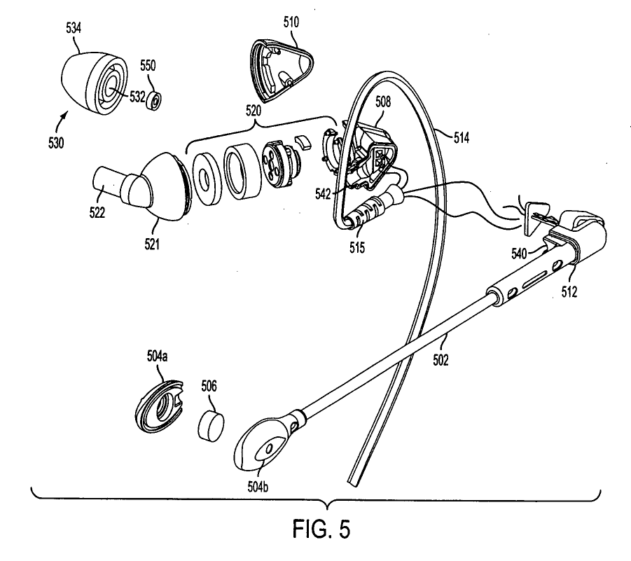

FIG. 5 shows details of an embodiment of the invention. A microphone boom 502 is attached at one end to a front microphone housing 504a, and rear microphone housing 504b. The boom 502 is of an appropriate length and is adjustable to position a microphone at the end near a user's mouth. The other end of the boom 502 is attached to a boom housing 512.

A microphone cartridge or element 506, as is known in the art, resides within the microphone housing. In this configuration, a directional microphone element, for example cardioid, bidirectional (“noise canceling”), or hypercardioid designs are preferable because such microphones can reject unwanted ambient noise. An omnidirectional microphone could also be used.

A case is formed by an outer case housing 508 and inner case housing 510. The case couples the boom housing 512 to an in-ear driver 520, as is known in the art, for example, the E2C in-ear driver manufactured by Shure Inc. of Evanston, Ill.

A front exiting cable 514 extends from the housing 512 and the outer case housing 508 in a direction parallel to the boom 502. Specifically, the cable 514 extends from a flex relief unit 515 from an opening formed by lip 540 of the housing 512 and lip 542 of the housing 508. The cable 514 is formed to be bendable to various shapes to accommodate a user's preference and, in this illustration, is bent upward such that the cable 514 could extend around the outer portion of a user's left ear. Alternatively, the cable 514 could be extended downward after exiting the housing formed by 508, 510, and the unit could then be extended around a user's right ear.

An end piece 521 includes a nozzle 522 and is coupled to the case housing 508, 510. The nozzle 522 extends into an earpiece 530 that frictionally engages the user's ear canal. The earpiece 530 includes a rigid plastic cylinder 532 that forms an opening and foam sleeve 534. Alternatively, earpiece 530 is made of plastic or silicone material, and has functional features of sleeve 534, which frictionally engages the ear canal, as well as function features of cylinder 530, which frictionally engages the nozzle 522. A plug 550 resides within the cylinder 532.

The sleeve 534 is compressible and forms to fit and frictionally engage the user's ear canal. The sleeve is sufficiently rigid that the entire headset assembly is supported by the engagement of the ear piece with the user's ear canal and without the need for additional tabs, fitments or other structure that engages the user's outer ear.

It is not necessary for the wire 514 to engage the user's ear to support the unit within a user's ear. The cable shown in FIG. 5 could engage a user's left ear to help support the unit. The cable 514 could also extend from the case 510 and drop straight down and not engage the user's outer ear. In that case, the frictional engagement of the earpiece 530 in the user's ear canal adequately supports the unit.

Thus, the in-ear design can provide comfortable support for lightweight headset boom without additional ear fitments.

In an alternative embodiment, a microphone is attached to the cable 514 at a point further along the length of the cable. This “lavalier-style” arrangement is similar to existing mobile phone “earbud” dangling-microphone headsets, as is known.

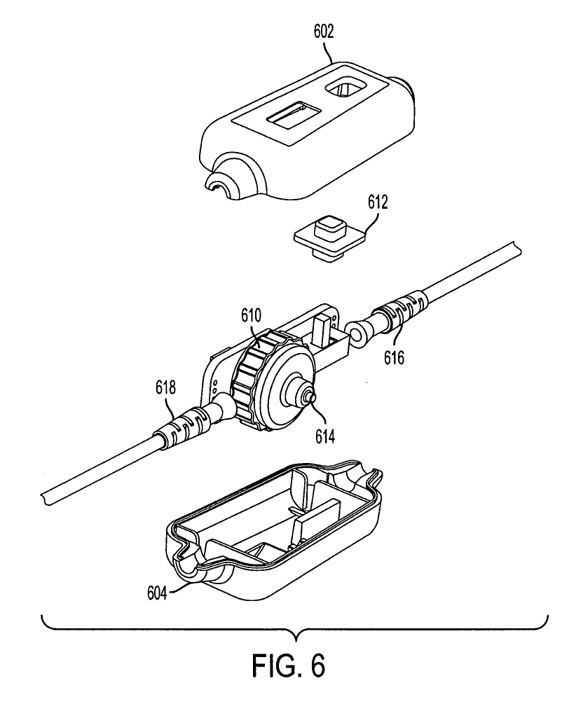

FIG. 6 shows additional detail of structural components of a control and volume assembly included in an embodiment of the invention. An upper cover 602 is affixed to a lower cover 604. The covers house controls for the communication headset that can perform various functions, for example, a volume control 610 and a mute control 612. Control 610 is a potentiometer and control 612 is a slide switch. The potentiometer rotates about a thumbwheel 614. Flex relief portions 616 and 618 extend from openings formed by the top cover 602 and the bottom cover 604.

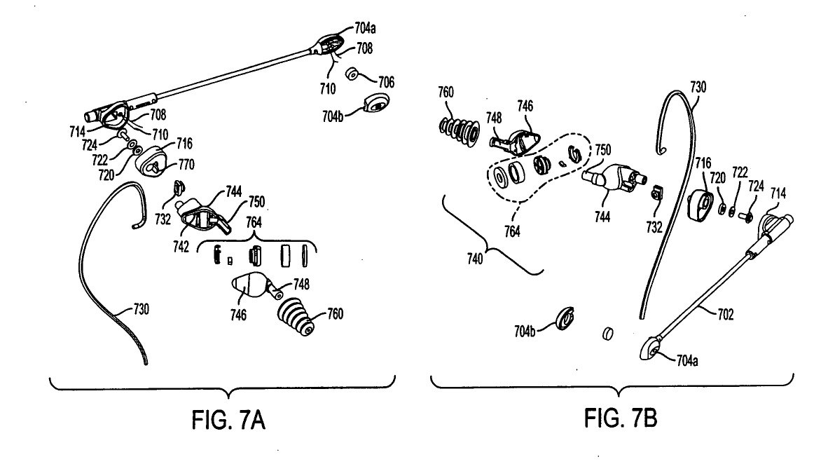

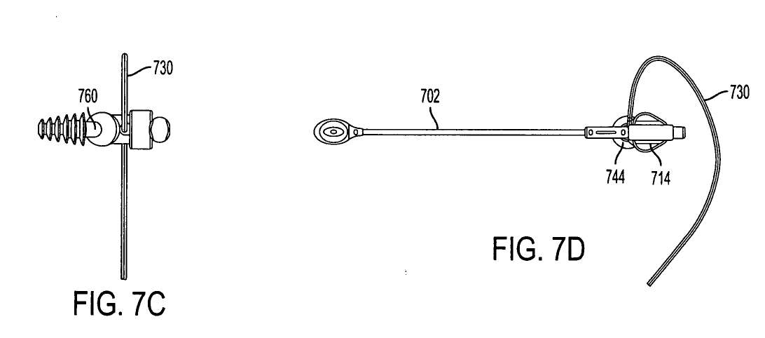

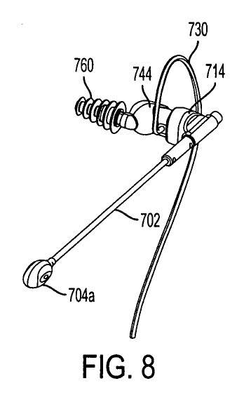

FIGS. 7A, 7B, 7C, 7D and 8 show details of an alternative embodiment of the invention. A rotating microphone boom 702 includes a microphone housing formed by front microphone housing 704a, and rear microphone housing 704b. A cartridge 706, as is known in the art, resides within the microphone housing.

As shown in FIG. 7A, microphone leads 708, 710 extend within the body of the boom 702. A microphone boom housing includes an outer boom housing 714 and an inner boom housing 716. The inner and outer boom housings 716, 714 house a bearing for a pivoting nylon washer 720, a stainless steel Belville washer 722 and a thread cutting Phillips round head 724. A front exiting cable 730 extends from the unit from a cable exit grommet 732.

An in-ear driver 740 is coupled to the outer boom housing 716. A wire (not shown) enters the driver 740 at an opening 742 in a bottom 744 of the driver, which also includes a top 746. End portions 748 and 750 form a cylinder or nozzle that extends into an opening in a silicone ear plug 760.

The boom 702 and the boom housing formed by boom housings 714, 716 are hingedly engaged with the driver 740 such that the boom 702 can rotate over a range of 60 degrees relative to the driver 740. A tab 770 acts as a pivoting lock that controls the rotation of the boom 702.

Details of the silicone earplug 760 are shown in FIG. 7c. The silicone earplug 760 can be cut to various lengths to accommodate a particular user. In one embodiment, the earplug 760 is 20 mm in length and can be cut to 16.5 mm, 13 mm, 9.5 mm and 6 mm lengths for various fits.

The driver 740 includes internal parts 764, as is known in the art, such as a Shure E2C driver, which is available from Shure Inc. in Evanston, Ill.

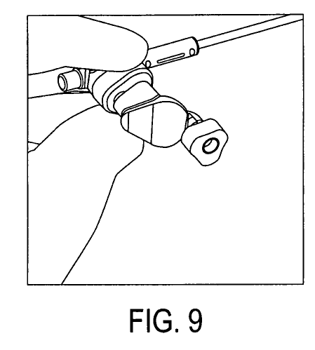

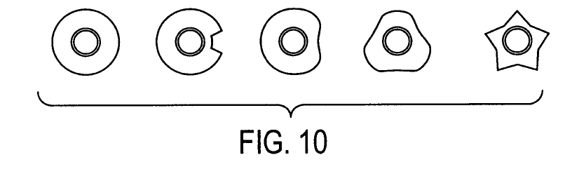

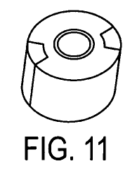

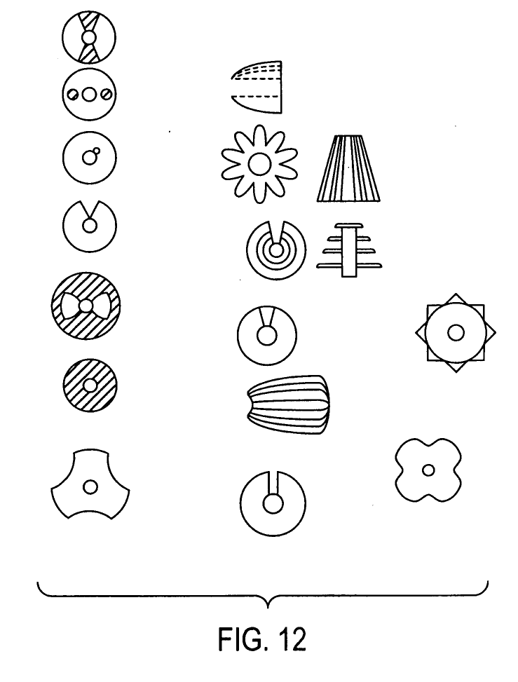

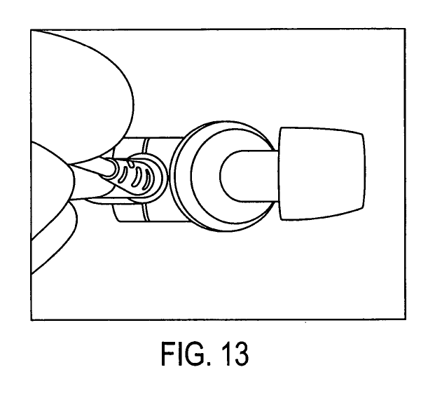

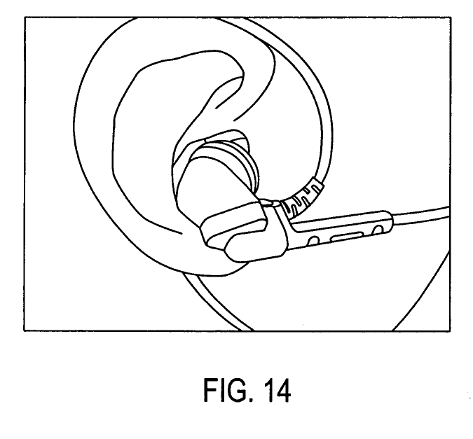

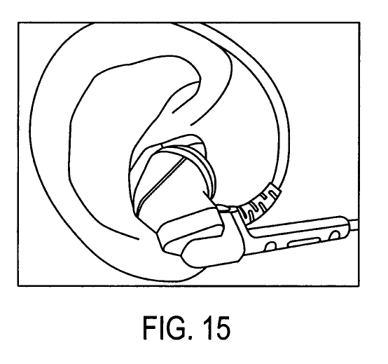

FIGS. 9-12 show various geometries of earpieces used with the invention. Various vented and partial isolation earpieces allow some ambient noise to leak in to the user's ear canal. Such leakage accommodates different user preference for ambience and allows the system to be used in environments where total isolation is not desirable. As illustrated in these figures, possible designs include small vents and open channels around outside of sleeve. Various embodiments of the invention include shapes such as stars, propellers, “C”s, kidneys and “starbursts.”

Additionally, various types of foam or plastic can be used for the sleeve portion of the earpiece, such as open cell low acoustic impedance foam, closed cell high acoustic impedance foam, PVC, plastic, or silicone. In a preferred embodiment, the foam used is closed cell high acoustic impedance foam. This foam permits acoustic isolation of 15 to 25 dB. In a second preferred embodiment, the sleeve portion of the earpiece is flexible PVC plastic. This PVC sleeve also permits acoustic isolation of 15 to 25 dB. Alternate embodiments, using combinations of materials, may reduce the acoustic isolation for a desirable effect, as low as 12 dB.

By selecting from such an assortment of earpieces, the user can personalize the fit of the in-ear earphones to his or her particular ears and also determine the level of acoustic isolation desired. The sleeves conform to the unique shape of a user's ear. Additionally, the customized in-ear fit can also eliminate the painful pressure points created by a typical earbud headset, enabling the user to wear the headset or longer periods of time.

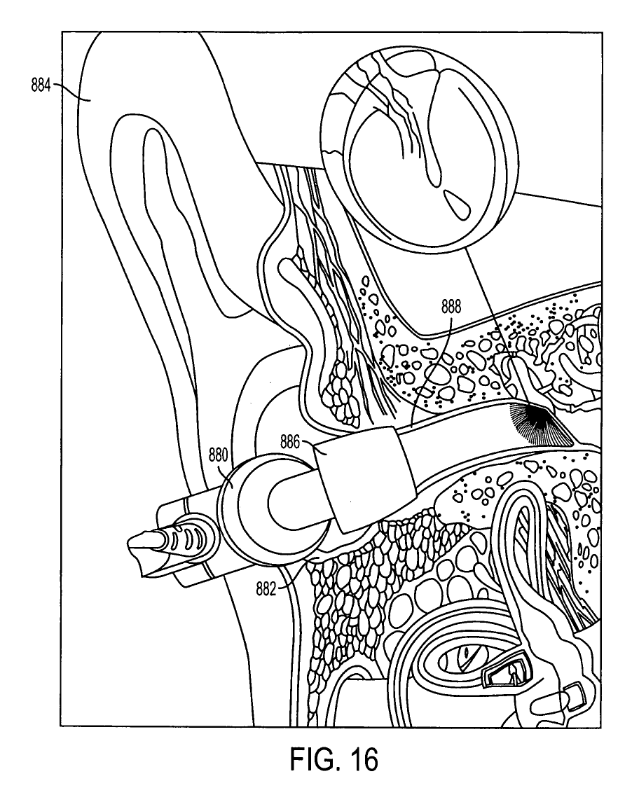

FIG. 16 shows frictional engagement of an ear piece 886 in an ear canal 888 of an ear 884. A portion of the housing 880 rests on a portion of the ear referred to by those skilled in the art as an ear bowl, the underside of which is shown at arrow 882. In FIG. 16, the earpiece 886 is not fully inserted into the user's ear canal.

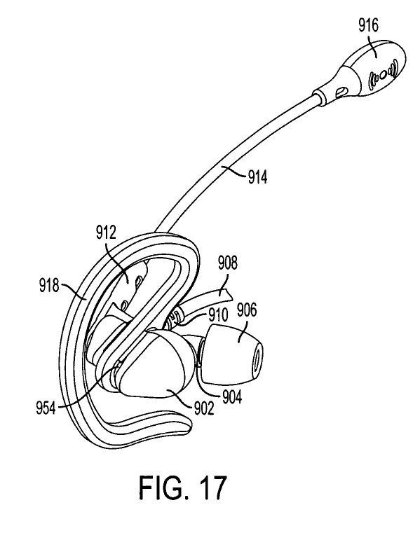

FIG. 17-22 show an alternative embodiment of the invention. As shown in FIG. 17, the invention includes a housing 902 and a nozzle 904 that extends from the housing 902. An ear piece 906 is coupled to the housing and obscures most of the view of the nozzle 904 shown in FIG. 17, which is similar to the nozzle 522 shown in FIG. 5. The housing 902 and the ear piece 906 together provide at least 15 dB of acoustic isolation from ambient sound over the range of audible frequencies. In a preferred embodiment, the housing 902 and the ear piece 906 together provide 15-25 dB of acoustic isolation

A cable 908 extends from the housing 902 and ultimately is coupled to a cellular telephone or other audio device. The cable 908 includes a strain relief portion 910. Also coupled to the housing 902 is a boom guide 912. The boom guide 912 can be made of a stiff, rigid material. Extending from the boom guide 912 is a flexible boom 914. A microphone assembly 916 is coupled to the end of the boom 914. The invention also includes a flexible ear support 918 that supports the headset on a user's ear. The ear support 918 is preferably made of a flexible rubber material.

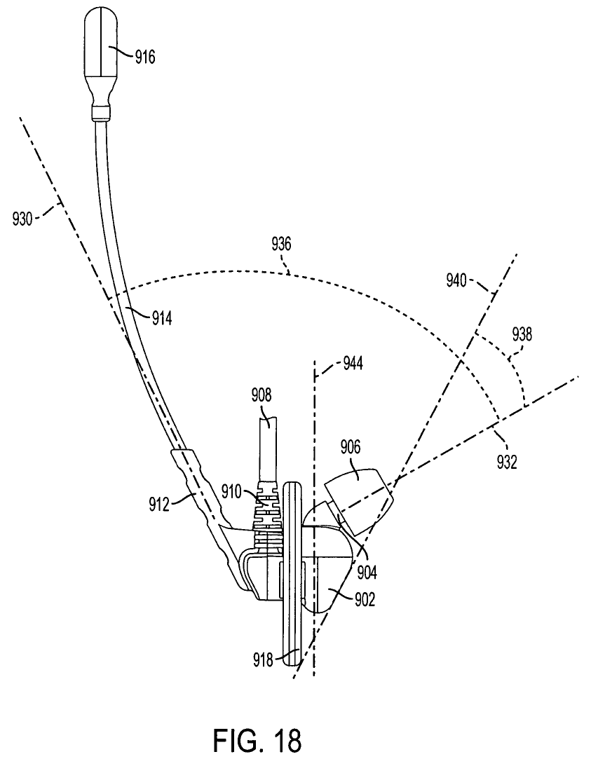

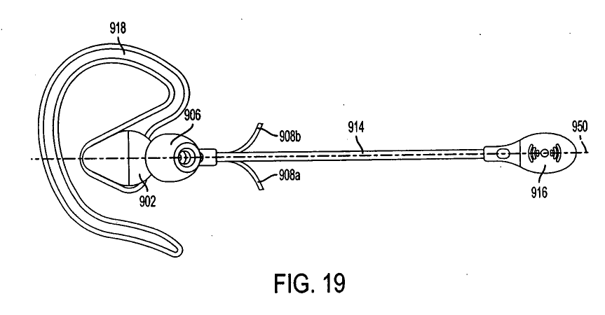

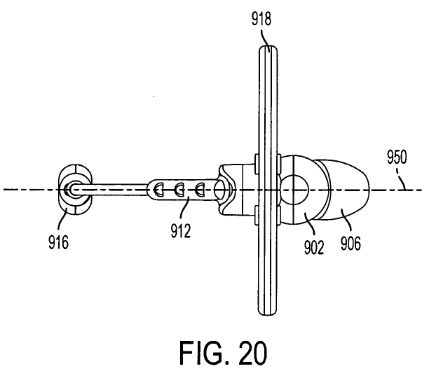

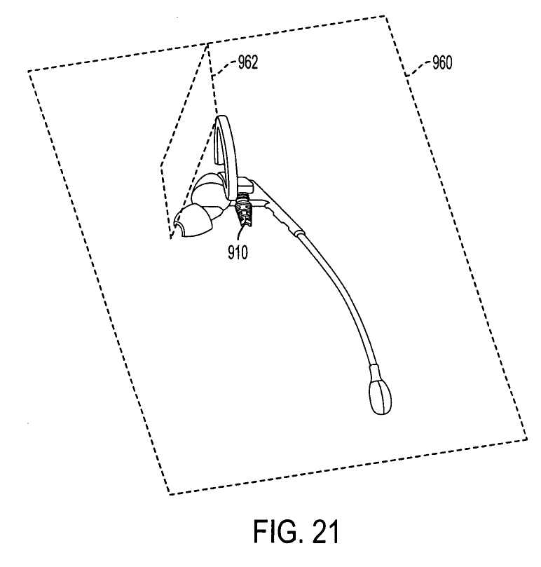

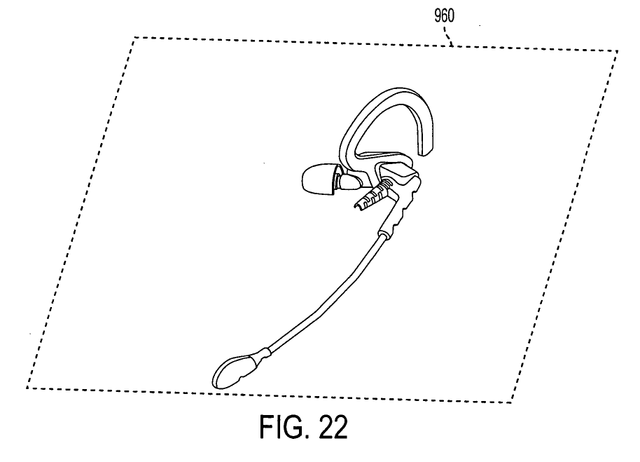

As illustrated in FIG. 18, the boom guide 912 forms, in its longitudinal direction, a boom axis as shown by the dashed line 930. The nozzle 904 forms in its longitudinal direction a nozzle axis as shown by the dashed line 932. The boom axis and the nozzle axis are coplanar and intersect at an angle shown at 936 in a plane of the paper that shows FIG. 18. This plane is also shown by a dashed line 950 in FIG. 19 and in FIG. 20. This plane is also illustrated by a dashed rectangle 960 shown in FIGS. 21 and 22.

Referring to FIG. 18, the angle 936 is in the range of about 77 degrees to about 97 degrees and is preferably about 87 degrees.

Referring still to FIG. 18, the headset rests on a user along a plane, shown by a dashed line 940 that extends orthogonally from plane defined by the paper of FIG. 18. The plane defined by dashed line 940 is further illustrated by the dashed rectangle 962 in FIG. 21. Specifically, the housing 902 rests in the user's ear in a portion of the ear referred by those skilled in the art as an ear bowl. As is shown in FIG. 16, the housing 880 rests along a user's ear bowl, the underside of which is shown at arrow 882, all of which is part of a user's ear 884. In FIG. 16, the earpiece 886 is not fully inserted into the user's ear bowl.

Referring to FIG. 18, in the first plane, the second plane orthogonal to the first plane defined by the dashed line 940 forms an angle 938 with nozzle axis, shown by line 932. The angle 938 is in the range of about 23 to 43 degrees and is preferably about 33 degrees.

In a longitudinal direction of the housing 902 is an axis, a housing axis, shown by a dashed line 944. When the axis defined by the line 944 is coplanar with the boom axis, shown by line 930, and the nozzle axis, shown by line 932, the boom axis and the nozzle axis extend angularly from the housing axis. The cable 908 extends from the housing 902 in a direction parallel to the housing axis shown by line 944. In certain embodiments, the housing may be of a shape such that it does not have a longitudinal direction.

Certain features of the geometry of the headset enhance its adaptability for use in either the user's left ear or right ear. Specifically, the nozzle 904, the boom assembly 912 and the cable 908 extend in a coplanar fashion in the plane shown by the dashed line 950 in FIG. 19 and FIG. 20 and by the dashed rectangle 960 shown in FIGS. 21 and 22. Additionally, the plane described above and shown at lines 960 in FIG. 21 is orthogonal to the plane shown by dashed lines 962 in FIG. 21. These features permit the user to interchangeably wear the headset on either a left ear or a right ear by simply slipping the ear support 918 over the housing 902, flipping by 180 degrees the ear support 918 and slipping it back over the housing 902. As illustrated in FIG. 17, the ear support 918 includes an opening, shown at 954, such that the ear support 918 can be slipped over the housing 902 and flipped to suit a user's preference for left or right ear operation.

In certain figures, e.g. FIGS. 21 and 22, the strain relief portion 910 of the cable is illustrated and the remaining portion of the cable 908 is not illustrated. Referring to FIG. 19, the cable 908 may extend down into the plane defined by line 950, as shown at 908a, or the cable 908 may extend up from the plane defined by line 950, as shown at 908b, depending on the preference of the user.

As is evident from the foregoing, the sealed acoustic path of the invention allows it to be used with a quiet mobile phone headset output or quiet far-end talker when mobile phone has volume turned up to maximum. This also can reduce the volume level needed to hear a talker speaking at a normal level. Additionally, the ear canal coupling improves low-end and mid-low frequency response, which are important for voice communication, as compared to most over ear headphones. The unit also requires less amplification power, resulting in a more efficient design and less power draw from a portable power source, that is, less battery drain.

The sound isolating design also results in natural noise attenuation provided by the sleeves, permitting lower listening volumes in loud environments. This minimizes listening fatigue and permanent or semi-permanent hearing impairment since the user does not need to boost the volume to compensate for external ‘spill’. This also means the signal will contain less distortion, which increases with increased amplitude.

The invention is also applicable to communications applications where the external, ambient sound being attenuated by the earpiece in one ear is desirable to hear in the other ear. In uses such as on-line gaming, a user may use the headset to carry on a conversation, but may at the same time want to hear ambient sound effects of the game being played with the open, unblocked ear. This invention allows the user to hear gameplay audio effects, yet improves communication. The earpiece makes the far-end talker more intelligible through attenuation of gameplay audio effects in one ear, and the microphone makes the near-end talker more intelligible by rejection of gameplay audio effects by employing a directional microphone element.

Another embodiment of the invention includes an electronically injected, adjustable ambience. Such an embodiment would use a small embedded microphone and allow the user to select a desirable amount of ambient noise/leakage by adding in local environment sound at an adjustable level to the sound delivered to the user's ear by the earpiece.

The invention can also include a two earpiece option for communications applications where complete isolation is desired. In such an embodiment, ear pieces are inserted into both ear canals. Such an application may be desirable for hearing preservation in high noise environments or where stereo listening is desired, for example, with multimedia devices, etc.

In the two earpiece configuration, the invention achieves lateralization of the sound being presented (giving the user the sensation that sound is coming from one direction more than the other) through the use of a level difference, a signal phase difference (˜180 degrees), or a time delay (interaural time difference, ITD, less than 100 ms) between the signals for the left and right ears. This lateralization could be used in a communications application to create a sense that the far-end talker signal was coming more from the right or more from the left, yet still allowing usage of both earpieces. This also raises the perceived loudness of the signal anywhere from 1.4-2 times, without actually employing a higher signal level in either individual ear.

The invention allows reduces acoustical echo between microphone and earpiece due to the isolation of the loudspeaker from the microphone via the ear canal loudspeaker location.

Alternatively, the in-ear driver technology could be employed along with an active noise canceling system, to achieve the benefits of both systems for very severe applications.

The system can also be employed in various wireless applications. For example, the headset may communicate wirelessly with a telephone handset, or the electronics for telephone communication may be contained in a housing. In such an application, there would be no need for a microphone cable such as cable 908 in FIG. 17 or 18.

In conclusion, herein is presented a communications headset. Accordingly, the invention is embodied in the form shown in the various drawings. Numerous variations are possible while maintaining the spirit of the invention. Such variations are contemplated as being part of the present invention

1. A communications headset comprising:
a housing comprising a speaker driver;
a nozzle for insertion into an ear canal, the nozzle coupled to the housing;
an acoustically isolating ear piece coupled to the nozzle, the ear piece and the housing providing at least 15 dB of acoustic isolation from ambient sound over the range of audible frequencies; and
a microphone.

2. A communications headset as in claim 1 wherein the ear piece provides acoustic isolation in the range of 15 to 25 dB from ambient sound over the range of audible frequencies.

3. A communications headset as in claim 1 wherein the ear piece comprises an opening and a flexible material adapted to frictionally engage an ear canal.

4. A communications headset as in claim 3 wherein the opening comprises a cylindrical, rigid tube and the flexible material comprises compressible foam surrounding the tube.

5. A communications headset as in claim 3 wherein the flexible material is plastic.

6. A communications headset as in claim 3 wherein the flexible material is silicone.

7. A communications headset as in claim 3 further comprising a boom assembly extending from the housing wherein the microphone is coupled to the boom assembly.

8. A communications headset as in claim 7 wherein the boom assembly comprises a rigid boom guide and a flexible boom.

9. A communications headset as in claim 7 wherein the longitudinal direction of the boom assembly defines a first axis and the longitudinal direction of the nozzle defines a second axis, wherein the first axis and the second axis intersect and define an angle in a first plane.

10. A communications headset as in claim 9 wherein the first angle is between about 77 and about 97 degrees.

11. A communications headset as in claim 9 wherein the first angle is about 87 degrees.

12. A communications headset as in claim 9 wherein the housing engages a user's ear in a second plane that is orthogonal to the first plane.

13. A communications headset as in claim 12 wherein the headset is symmetrical for use in either a user's left ear or a user's right ear.

14. A communications headset as in claim 12 wherein the second plane and the second axis define a second angle of between about 23 and about 43 degrees.

15. A communications headset as in claim 14 wherein the second angle is about 33 degrees.

16. A communications headset as in claim 9 further comprising a cable extending from the housing and defining a third axis and wherein the first axis, the second axis and the third axis are coplanar.

17. A communications headset as in claim 1 further comprising a flexible ear support.

18. A communications headset as in claim 3 wherein the ear piece solely supports the communications headset on the user.

19. A communications headset as in claim 1 further comprising a cable extending from the housing, the cable providing an input signal to the speaker driver and an output signal from the microphone.

20. A communications headset as in claim 19 wherein the microphone is coupled to the cable.

21. A communications headset as in claim 19 wherein the cable cooperates with the ear piece to support the communications headset on the user.

22. A communications headset as in claim 1 wherein the microphone is directional.

23. A communications headset as in claim 22 herein the microphone is selected from the group consisting of cardioid microphones, bi-directional microphones and hypercardioid microphones.

24. A communications headset as in claim 1 wherein at least some ambient sound is electronically transmitted to the driver.

25. A communications headset as in claim 1 wherein the microphone is acoustically isolated from the driver signal and thereby reduces echo to a far-end talker.

26. A communications headset as in claim 3 wherein the flexible material is formed in a shape from the group consisting of a star, a kidney bean, a triangle, a starburst, a propeller and the letter C.

27. A communications headset as in claim 1 wherein the ear piece comprises a plurality of openings and a flexible material adapted to frictionally engage an ear canal.

28. A communications headset comprising:
a boom guide defining a first axis in its longitudinal direction;
a nozzle for insertion into an ear canal, the nozzle defining in its longitudinal direction a second axis and extending angularly from the first axis
a housing comprising a speaker driver, the nozzle coupled to the housing, the housing defining in its longitudinal direction a third axis, the first axis and the second axis extending angularly from the third axis;
an acoustically isolating ear piece coupled to the nozzle;
a boom extending from the boom guide; and
a directional microphone coupled to the boom.

29. A communications headset as in claim 28 further comprising a cable extending from the housing in the direction of the third axis, the cable proving an input signal to the speaker driver and an output signal from the microphone.

30. A communications headset as in claim 28 wherein the boom is rigid.

31. A communications headset as in claim 30 wherein a portion of the boom is rigid and a portion of the boom flexible.

32. A communications headset as in claim 28 wherein the first axis and the second axis define a first plane and the first axis and the second axis intersect and define in the first plane a first angle.

33. A communications headset as in claim 32 wherein the first angle is from about 77 to about 97 degrees.

34. A communications headset as in claim 32 wherein the first angle is about 87 degrees.

35. A communications headset as in claim 32 wherein the housing engages a user's ear in a second plane that is orthogonal to the first plane.

36. A communications headset as in claim 35 wherein the headset is symmetrical for use in either a user's left ear or a user's right ear.

37. A communications headset as in claim 35 wherein the second plane and the second axis define a second angle of between about 23 and about 43 degrees.

38. A communications headset as in claim 37 wherein the second angle is about 33 degrees.

39. A communications headset as in claim 28 further comprising a cable extending from the housing and defining a third axis and wherein the first axis, the second axis and the third axis are coplanar.

40. A communications headset as in claim 28 wherein the ear piece comprises an opening and a flexible material adapted to frictionally engage an ear canal.

41. A communications headset as in claim 40 wherein the flexible material is plastic.

42. A communications headset as in claim 40 wherein the flexible material is silicone.

43. A communications headset as in claim 40 wherein the opening comprises a cylindrical, rigid tube and the flexible material comprises compressible foam surrounding the tube.

43. A communications headset as in claim 28 wherein the ear piece and the housing provides acoustic isolation of at least 15 dB from ambient sound over the range of audible frequencies.

44. A communications headset as in claim 43 wherein the ear piece provides acoustic isolation in the range of 15 to 25 dB from ambient sound over the range of audible frequencies.

45. A communications headset as in claim 28 further comprising a flexible ear support.

46. A communications headset as in claim 28 wherein the ear piece solely supports the communications headset on the user.

47. A communications headset as in claim 28 wherein at least some ambient sound is electronically transmitted to the driver.

48. A communications headset as in claim 28 wherein the microphone is acoustically isolated from the driver signal and thereby reduces echo to a far-end talker.

49. A communications headset comprising:
a first housing for a first ear, the first housing comprising a first speaker driver;
a second housing for a second ear, the second housing comprising a second speaker driver;
a first nozzle for insertion into the first ear canal, the first nozzle coupled to the first housing;
a second nozzle for insertion into the second ear canal, the second nozzle coupled to the second housing
a first acoustically isolating ear piece coupled to the first nozzle, the first ear piece and the housing providing at least 15 dB of acoustic isolation from ambient sound over the range of audible frequencies;
a second acoustically isolating ear piece coupled to the second nozzle, the second ear piece and the second housing providing at least 15 dB of acoustic isolation from ambient sound over the range of audible frequencies; and
a microphone.

50. A communications headset as in claim 49 further comprising lateralization means for manipulating a first signal to the first speaker driver and a second signal to the second speaker driver to create a sensation that sound is coming from one direction more than from another direction.

51. A communications headset as in claim 50 wherein the lateralization means comprises at least one of the following steps: manipulation of a level difference, manipulation of a phase difference and manipulation of an intraural time difference.
